(19) United States
(12) Patent Application Publication
(10) Pub. No.: US 2007/0078857 A1
(43) Pub. Date: Apr. 5, 2007

(54) Method and a device for browsing information feeds

(75) Inventors: Murali Punaganti, Vantaa (FI); Sameh Galal, Cairo (EG); Chand Malu, Vantaa (FI)

Correspondence Address: Ware, Fressola, Van Der Sluys & Adolphson, LLP;Building Five, Bradford Green, 755 Main Street, P.O. Box 224, Monroe, CT, 06468, US

(73) Assignee: Nokia Corporation

(21) Appl. No.: 11/241,884

(22) Filed: Sep. 30, 2005

(51) Int. Cl. G06F 17/30

(52) U.S. Cl. 707/10

(57) ABSTRACT

A method and a mobile terminal executing the method for browsing available information feeds on a limited display area via sequential views. Items of a certain feed are first listed by utilizing representative identifiers. The user of the terminal device may through swift, 1-click type actions then inspect the descriptions of preferred items one at a time before selecting the item to be fully accessed.

### TECHNICAL FIELD

The present invention generally relates to mobile, e.g. hand-held, terminal devices with limited user interfaces. Especially the invention concerns browsing of received information feeds and accessing data contained therein.

### BACKGROUND OF THE INVENTION

The current trend in point-to-multipoint data transmission over the Internet is towards publish-subscribe arrangements such as different news services utilizing e.g. RDF (Resource Description Framework), RSS (Really Simple Syndication, RDF Site Summary) or Atom as a so-called Web content syndication system. In the world of publish-subscribe systems the subscribers (clients) subscribe to a feed (˜channel) that is, in practise, an XML (Extensible Mark-up Language) document behind a certain URL (Uniform Resource Locator) accessible via HTTP (Hypertext Transfer Protocol). The XML document comprises a list of items constituting the feed. Information publishers provide each feed with the corresponding items forming the feed content that is typically also regularly revised including deletion of old items and addition of new ones. Different feeds are available on various topics and the clients poll the feed to receive updates on the feed items.

RSS is a relatively simple XML format/dialect used for content syndication over the Internet. It was originally mainly targeted for providing micro news services comprising only textual content whereas the most recent hype is about true multimedia feeds comprising also audio and image data. An aggregator is a client application running in a client device that can be used to simultaneously keep track of various subscribed (news) feeds without a need to inconveniently and definitely time-consumingly access the relating feed sites with a web browser, one at a time. Podcasting, combining the terms “broadcasting” and “iPod” (trademark of Apple Computer, Inc), refers to the utilization of RSS (especially 2.0 version allowing the enclosure elements) for delivering binary media such as audio, video, images, etc. In contrast to an entry level news feed aggregator, where the user presses a certain (software) button for updating a feed, Podcasting applications and also other more sophisticated feed aggregators are configured to automatically check the subscribed feeds for updates in a periodic manner. New binary content such as MP3 files are then automatically downloaded to the client device for later exploitation by the user. RSS/Podcasting applications naturally also bear necessary means for the detection of already downloaded content in order to spare transfer resources of the server providing the feed, the network in between, and the local client. More information about the RSS and Podcasting in general can be found in the references [1] and [2].

Modern news aggregators or Podcasting applications work fine on client machines that contain a large display and sophisticated user input means like a keyboard, a mouse, etc. This often is the case with contemporary computers, both laptop and desktop, but not with hand-held devices, e.g. mobile terminals or most PDAs (Personal Digital Assistant). Currently there are no well-defined or well-established UIs (User Interface) for receiving information feeds or user input in such limited UI devices. A common frame-based approach wherein e.g. one frame is used for listing the feeds and the rest are dynamically created for displaying the content of each feed is not applicable with a small, relatively low-resolution screen (e.g. having a physical width of few inches and a resolution of 320×200 pixels) currently present in most terminal devices. Yet, as space-consuming but versatile control input means like a mouse are excluded from small-sized terminals, whereupon the user input provided with more typical button arrangements become easily more complicated.

See FIG. 1 for further visualization of a prior art feed reader/aggregator UI that reminds of an e-mail client software. The reader application runs in a standard (desktop) computer having a large size display 102 and user input means including a keyboard 104 and a mouse 106 for providing the application with necessary control input. The application window is divided into a plurality of frames 108, 110, 112, and 114, each having a different purpose. Frame 110 shows the subscribed feeds, frame 112 lists the items within a selected feed, and frame 114 discloses the internals of a single item in the selected feed. Frame 108 comprises necessary buttons etc for controlling the application via the mouse 106. It's quite evident that a similar arrangement of visualized elements does not work in portable devices having only a modest size display.

### SUMMARY OF THE INVENTION

The object of the invention is to facilitate browsing information feeds in a terminal device equipped with a limited-size display. The object is achieved by a solution utilizing several sequential views wherein multiple items of a selected feed are first visualized on the display via a list of identifiers, e.g. titles, of each item, and where an abstract of a selected item as indicated by the subsequently received control input from the user is then shown instead. The user may advantageously highlight a certain identifier from the visualized list by utilizing simple (e.g. up/down) control features, e.g. buttons, via the UI of the terminal device. The highlighted identifier can be selected by a further 1-click control input for analysis in the abstract view. The abstract view discloses additional information, e.g. an abstract and title, of the item behind the selected identifier. Through another predetermined 1-click operation the abstract view can be updated to visualize the other items, the execution of the method may be reverted to the list view, or the item represented by the abstract view may be actually accessed.

In an aspect of the invention a method for browsing items of an information feed to be performed by a terminal device operable in a telecommunications network, wherein a number of subscribed information feeds are received by said terminal device via said telecommunications network, has the steps of:
selecting a certain information feed,
constructing a list view to be visualized on a predetermined area of the display of the terminal device, said list view comprising a plurality of identifiers each of which relating to one item of the selected feed, and wherein one identifier is highlighted, so that in response to a predetermined control input the highlighted identifier is changed,
obtaining a 1-click control input defining a selection of the currently highlighted identifier,
responsive to the 1-click control input constructing an abstract view to be visualized on said predetermined area of the display of the terminal device, said abstract view comprising a description of the item relating to the selected identifier, so that in response to a further predetermined control input the abstract view is updated to comprise a description of an item having an identifier adjacent to the selected identifier in the list view, said further predetermined control input also being a 1-click input,
obtaining a 1-click control input defining a selection of the current abstract view, and
performing an action in order to access the item relating to the current abstract view.

In the above, the term “1-click” refers to a received control input that can be given by the user as a single stroke (button/key, touch screen portion, etc) or as a corresponding continuous gesture, for example, turning a TrackPoint type controller etc to a certain direction. Such simple action will advantageously be converted into equally straightforward control information in the receiving device that can rapidly execute the responsive actions.

In another aspect a mobile terminal operable in a telecommunications network and capable of receiving and browsing a number of subscribed information feeds, said terminal comprising a processing unit for processing instructions and data, a memory unit for storing said instructions and data, a display for visualizing data, and user input means for gathering control input, is arranged to
select a certain information feed,
construct a list view to be visualized on a predetermined area of the display, said list view comprising a plurality of identifiers each of which relating to one item of the selected feed, and wherein one identifier is highlighted, so that in response to a predetermined control input to change the highlighted identifier,
obtain a 1-click control input defining a selection of the currently highlighted identifier,
responsive to the 1-click control input construct an abstract view to be visualized on said predetermined area of the display of the terminal device, said abstract view comprising a description of the item relating to the selected identifier, so that in response to a further predetermined control input to update the abstract view to comprise a description of an item having an identifier adjacent to the selected identifier in the list view, said further predetermined control input also being a 1-click input,
obtain a 1-click control input defining a selection of the current abstract view, and
perform an action in order to access the item relating to the current abstract view.

The utility of the invention arises from a plurality of issues. First, the proposed arrangement exploits the allocated and inevitably somewhat limited display area of the mobile terminal device comprehensively as the actions in different views take place in the very same display area with the exception of possible top/bottom bars or other, possibly dynamically allocated/unallocated, areas that are utilized to display supplementary information either relating (available functions behind the UI buttons or further info relating to the selected item, etc) or not (clock and date, incoming call or message, etc) to the inventive process. Accordingly, space is not wasted for visualizing multiple windows or frames when the user actions are still typically concentrated on one window/frame at a time, such window/frame referring to one feed and associated item thereof having catched the interest of the user. This is made possible by creating a logical and fast-to-use/fast-to-adopt user interface consisting of both the on-screen visualization and control input reception aspects. Even without large scale graphical representations and multiple windows/frames, the proposed method utilizing both vertical-like browsing (lists) and horizontal-like browsing (movements between the abstracts) in addition to swift 1-click type selections, the user may cleverly surf in the feeds' data space. The suggested solution is respectively efficient from the standpoints of memory consumption and processing requirements.

In one embodiment of the invention a plurality of information feeds are received in a mobile terminal. A certain news feed is then determined for further investigation and an item of the feed is subsequently selected, preliminarily analysed, and finally accessed in accordance with the suggested method.

### BRIEF DESCRIPTION OF THE DRAWINGS

In the following, the invention is described in more detail by reference to the attached drawings, wherein

FIG. 1 illustrates a typical prior art feed aggregator in which information feeds and items thereof are handled through multiple simultaneous windows.

FIG. 2 is a visualization of the browsing concept of the invention.

FIG. 3 is a flow diagram of one option for carrying out the method of the invention.

FIG. 4 is a block diagram of an electronic device adapted to execute the method of the invention.

### DETAILED DESCRIPTION OF THE PRESENTLY PREFERRED EMBODIMENTS

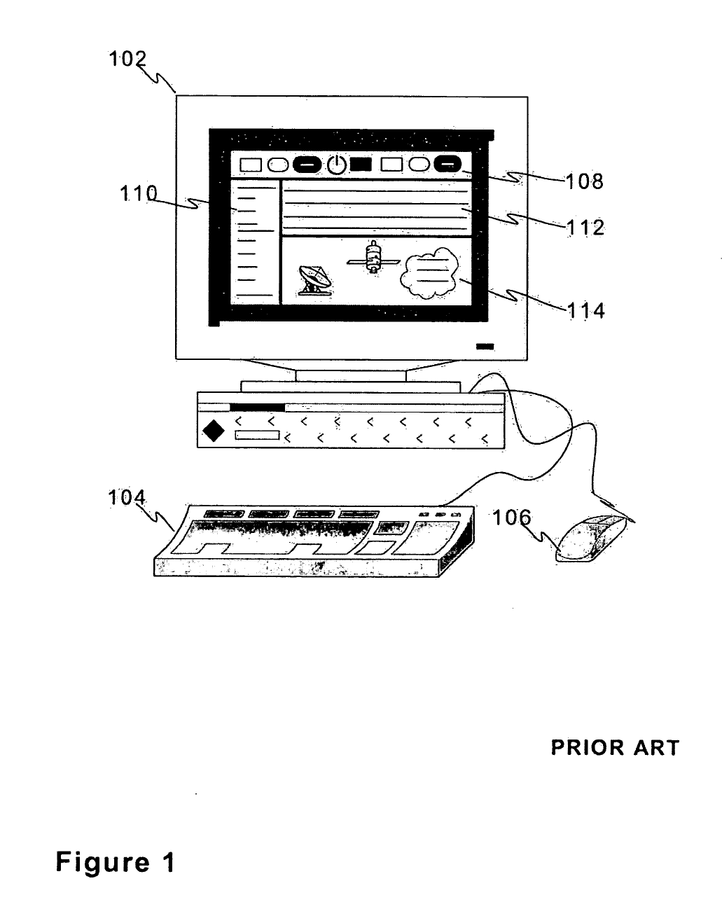

FIG. 1 was already reviewed in conjunction with the description of related prior art.

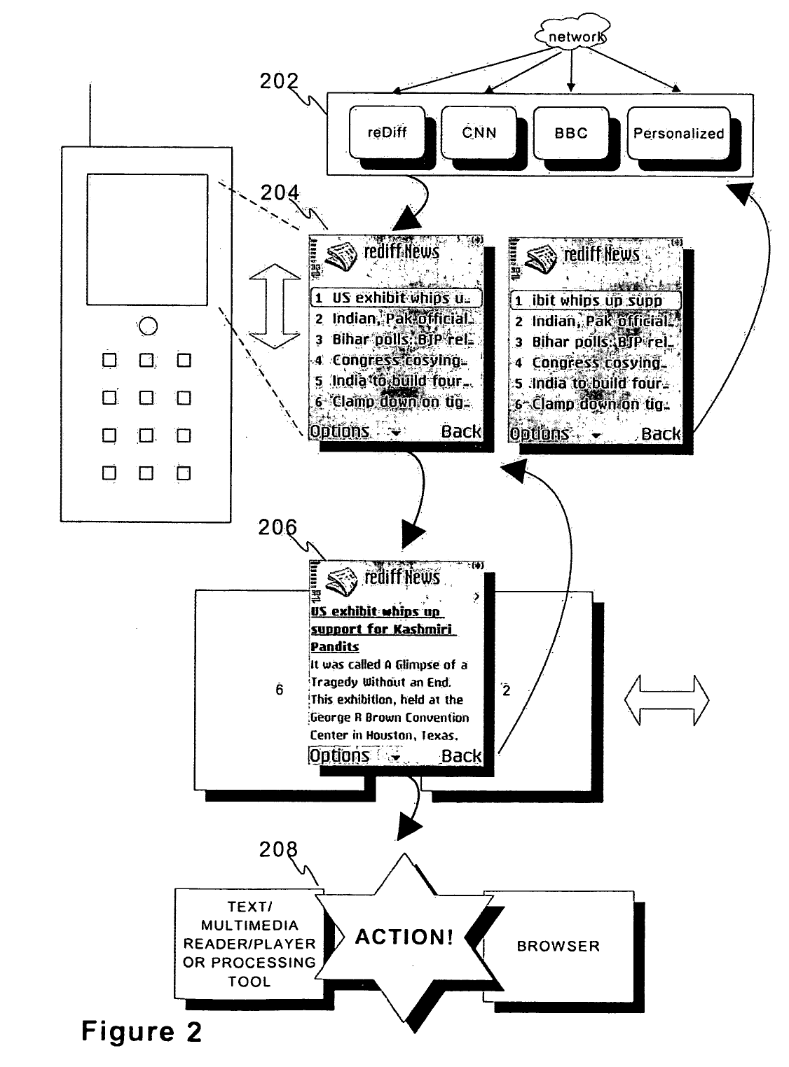

FIG. 2 visualizes the overall concept of the invention. A terminal device includes necessary means such as a transceiver for connecting to the network such as a radio access network of a mobile telecommunications network and interconnected networks. The user of the terminal has subscribed to a plurality of information feeds from different sources. The client application residing in the terminal updates the local feed information/contents as determined by the current settings. When the user wants to have a personal update on the various feeds, he activates the client application and selects a preferred feed for further investigation, see reference numeral 202. In this exemplary case, a news feed called “reDiff” is selected among other alternatives “CNN”, “BBC”, and “Personalized”, which may refer to an aggregate feed comprising filtered content of other feeds, for example. Personalized feeds are to be discussed in more detail hereinafter.

Different items of the selected feed are listed on the display of the terminal via identifiers, which may be textual and/or graphical, and the user may highlight, e.g. shadow with a user input controlled movable (see the hollow arrow) horizontal bar, the most interesting item identifier to optionally receive some additional information, see reference numeral 204. For example, if the screen width does not allow showing the whole item identifier, e.g. the title, the text in the row of the highlighted identifier may scroll (notice the two screen shots in the figure representing two different time instants) or the scrolling of the identifier text may be introduced in some other portion of the screen, e.g. the top bar. Now if the user inputs a predefined command via a specific 1-click action, the currently highlighted (referring to some recognizable visual clue) identifier is selected and the description, e.g. an abstract, of the relating item is shown, see numeral 206. In accordance with another predefined input (e.g. press of a button associated with the visual clue “back”), the display view is reverted to the feed selection.

In the abstract view 206, wherein the abstract comprising a description of the item with identifier (and in this case also the title) “US exhibit . . . ” is visualized utilizing the same display area as the item identifier list during the previous phase, also the adjacent abstracts (numbers 2 and 6 in the exemplary list of only six items in total) may be easily accessed by the user by pressing e.g. directional (left/right, see the hollow horizontal arrow visualizing this aspect) buttons (considered equal with “keys”) of the terminal UI for circulating the descriptions. The current abstract can be internally navigated with other buttons, e.g. up/down buttons. Correspondingly, a separate set of buttons may be allocated for triggering the return step to the item list (e.g. “back”) and the final selection of the currently visualized abstract, which launches the execution of the associated action, see reference numeral 208. Depending on the item type and/or predetermined settings, the action may refer to launching one or more dedicated applications such as a browser or a text/multimedia viewer/editor for accessing the item in full detail.

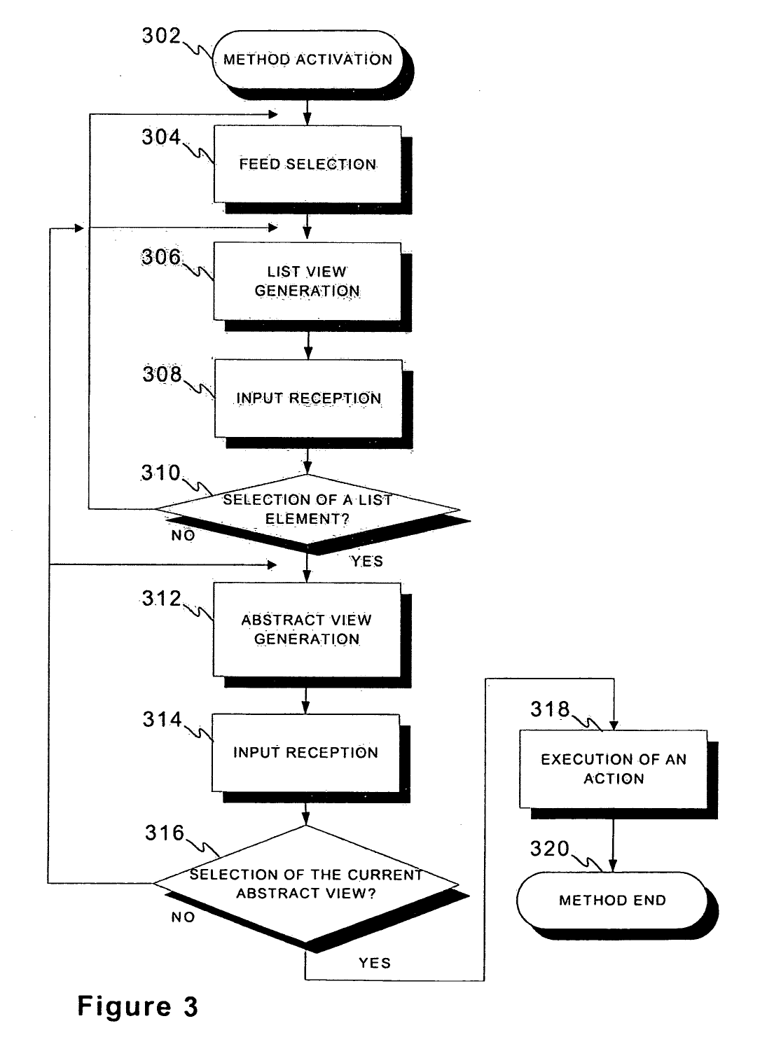

Next, in order to illuminate the feasibility of the invention in more structured terms, the flow diagram of FIG. 3 shall be reviewed herein and partly also expanded. It's obvious to a person skilled in the art that the depicted diagram discloses only one step-by-step option from many for carrying out the method of the invention.

During method activation 302 the user of the executing terminal device, the device being e.g. a mobile terminal, activates the feed reader application (aggregator, Podcasting application, etc) in order to check out the latest items in the subscribed and/or personalized feeds. By this point the terminal has obviously subscribed to the feeds and based on the settings (e.g. timer(s) or manual/parameter based triggering) updated the feeds at the local end. Some of the feeds may be so-called personalized feeds that refer to an aggregate feed constructed on the basis of user preferences. User preferences may be stored as filter parameters (feed/item topic like sports/news/literature, creation date, creator, key words included, language, length, etc) that affect feed/item selection process. The personalized feed(s) can be created from the already existing subscribed feeds and relating information via filtering, or the client may be configured to search the network for new feeds with preferred qualities and subscribe into those automatically or through user confirmation. Naturally the feeds acting as a source for personalized feed(s) may be subjected to filtering either locally in the client or already upon data reception.

In step 304 the user and consequently the terminal through the recognition of the received control input selects the feed for further analysis. Such selection may be graphical in which case the feeds are listed as text and/or symbols, and the user picks up the preferred one by utilizing the UI (buttons, directional controller, etc) of his terminal.

In step 306 the list view is generated comprising the identifiers for each item of the selected feed. An identifier as such may be fully user-definable for each feed meaning an explicitly stored association of the identifier with the feed, or the identifier directly refers to some specific parameter or field, e.g. the title of the item, in the feed itself. The list view can be, for example, carried out by visualizing each identifier on a separate row and highlighting (bolding, coloring, shadowing, separate position marker, etc) one identifier (the default one could be the first identifier listed, the actual ordering may be based on alphabetical rules etc) at a time as being currently pre-selected for the next method phase and for which also additional information is optionally shown. Optionally the identifier text of the highlighted item is scrolled either in its original position or e.g. in the top/bottom bar, if it's too long to be fitted on the screen area as such. Further, the navigation history may be visualized in relation to each item; e.g. different colors or additional markings may be used for distinguishing previously unread/unaccessed items from the read/accessed ones, in which case also the navigation history must be stored in the client. In addition, the list view may show the feed title and some button-associated functions (e.g. navigation back to the feed selection or identifier selection) in the top/bottom bars. Preferably the user may via control input easily (e.g. 1-click) determine the identifier to be highlighted. For this purpose e.g. up/down directional control or e.g. quick selection buttons associated with each visualized identifier shall be utilized. Likewise, as the selection of the highlighted identifier shall be as user-friendly as possible, 1-click operation is again exploited.

The terminal receives and monitors the control input from the user, see steps 308 and 310, and performs the associated actions. The input may relate to determining a new highlighted identifier or backtracking to the feed selection, see the upward arrows in “NO” path. Alternatively, the input may indicate the selection of the highlighted identifier (“YES”) in which case the method execution continues from step 312 wherein the abstract view (or a ˜“tab view” wherein each abstract is considered as a single tab) for the item associated with the selected identifier is constructed. The abstract view may include textual and/or other data types (even audio) extracted and/or derived from the item data for describing and representing the item. E.g. explicit title and description fields of the RSS type feed can be used as information sources for generating the abstract view for each item.

In step 314 more control input from the user is gathered. In step 316 it's checked by analysing the input whether the input relates to, for example, scrolling or otherwise altering the current abstract view, changing the abstract view in relation to the selected item, reverting to the item identifier selection (paths diverging from “NO”), or selecting the current abstract view for performing an associated, either generally set or an item dependent action (“YES”). In step 318 the action is executed, which may refer to launching an application fully supporting the media types of the item or just representing all the information contained in the item within the feed reader client if the capabilities thereof enable that. For example, if the item is a news article comprising a number of images in addition to mere text, the abstract view may disclose only a short textual summary whereas performing action refers to visualizing the full article with an appropriate additional application(s) if required. If the item refers to a number of resources still located in the network, the action may include accessing and downloading such content for local exploitation. In step 320 the method is ended as a response to a corresponding, predetermined user input.

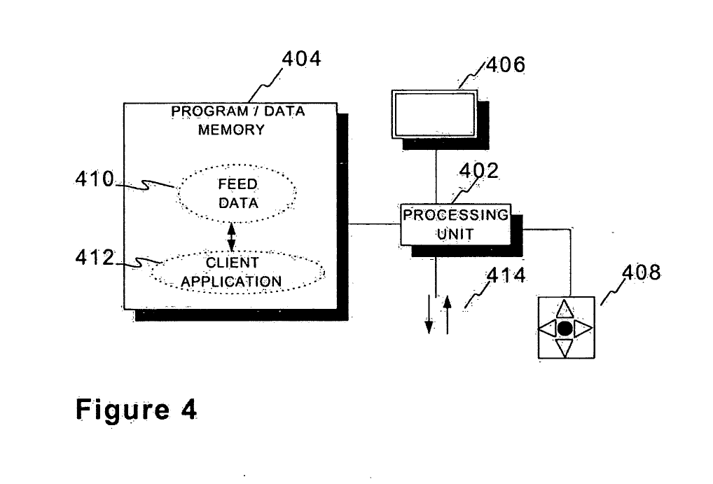

FIG. 4 shows a block diagram of a mobile terminal such as a modem mobile phone (GSM, UMTS, etc) or a communications-enabled PDA adapted to execute the method of the invention. The device includes a processing unit 402 that may be implemented in a form of a processor, a programmable logic chip, a DSP, a micro-controller, etc to carry out the method steps as set down by the circuit structure itself or the feed client application 412 stored in a memory 404. The memory 404, e.g. one or more memory chips, a memory card, or a magnetic disk, further comprises space 410 to accommodate e.g. received feed relating data. User/control input means 408, by which it is referred to the actual control means in hands of the user or just appropriate interfacing means, may include a keypad/separate buttons, a track ball/point or other dedicated directional controller, a pressure sensitive touch pad/screen, optical and/or capacitive sensors, etc. Display 406 refers to a display screen (crt, tft, lcd, etc.) or different projection means like a data projector. The display 406 may further refer to means for interfacing/controlling the display device that is not included in the device as such. Transmission means 414 enable the terminal to establish a connection(s) to the compatible network(s) for receiving and transmitting data. Such transmission means 414 may include e.g. a wireless transceiver (radio frequency, infrared, etc).

Code for application 412, generally called a computer program (product), to carry out the method steps of the invention may be provided to the executing device on a separate carrier medium such as a memory card, a magnetic disk, a cd-rom, etc.

The scope of the invention is found in the following claims. Although a few more or less focused examples were given in the text about the invention's applicability and feasible implementation, the purpose thereof was not to restrict the usage area of the actual invention to any certain implementation, which should be evident to skilled readers. For example, (1-click) control input may also be implemented via reception of voice commands instead of monitoring more traditional input means such as a keypad.

### REFERENCES

[1] Wikipedia: http://en.wikipedia.org/wiki/RSS_(protocol)
[2] Wikipedia: http://en.wikipedia.org/wiki/Podcasting

What is claimed is:

1. A method for browsing items of an information feed to be performed by a terminal device operable in a mobile communications network, wherein a number of subscribed information feeds are received by said terminal device via said mobile communications network, said method having the steps of:
selecting a certain information feed,
constructing a list view to be visualized on a predetermined area of the display of the terminal device, said list view comprising a plurality of identifiers each of which relating to one item of the selected feed, and wherein one identifier is highlighted, so that in response to a predetermined control input the highlighted identifier is changed,
obtaining a 1-click control input defining a selection of the currently highlighted identifier,
responsive to the 1-click control input constructing an abstract view to be visualized on said predetermined area of the display of the terminal device, said abstract view comprising a description of the item relating to the selected identifier, so that in response to a further predetermined control input the abstract view is updated to comprise a description of an item having an identifier adjacent to the selected identifier in the list view, said further predetermined control input also being a 1-click input,
obtaining a 1-click control input defining a selection of the current abstract view, and
performing an action in order to access the item relating to the current abstract view.

2. The method of claim 1, wherein the highlighted identifier comprises text that is scrolled on the display.

3. The method of claim 1, wherein previously accessed and unaccessed item identifiers are visualized in a separate fashion.

4. The method of claim 1, wherein a personalized feed is created by filtering data of at least one existing feed based on user preferences.

5. The method of claim 1, wherein said action is selected from the group consisting of: launching an application, opening the item in the current application, and connecting the network for receiving further data.

6. The method of claim 1, wherein said control input is selected from the group consisting of: a button press, directional controller data, voice command.

7. A mobile terminal operable in a communications network and capable of receiving and browsing a number of subscribed information feeds, said terminal comprising a processing unit for processing instructions and data, a memory unit for storing said instructions and data, a display for visualizing data, and user input means for gathering control input, said mobile terminal being arranged to
select a certain information feed,
construct a list view to be visualized on a predetermined area of the display, said list view comprising a plurality of identifiers each of which relating to one item of the selected feed, and wherein one identifier is highlighted, so that in response to a predetermined control input to change the highlighted identifier,
obtain a 1-click control input defining a selection of the currently highlighted identifier,
responsive to the 1-click control input construct an abstract view to be visualized on said predetermined area of the display of the terminal device, said abstract view comprising a description of the item relating to the selected identifier, so that in response to a further predetermined control input to update the abstract view to comprise a description of an item having an identifier adjacent to the selected identifier in the list view, said further predetermined control input also being a 1-click input,
obtain a 1-click control input defining a selection of the current abstract view, and
perform an action in order to access the item relating to the current abstract view.

8. The mobile terminal of claim 7, further arranged to scroll the text of the highlighted identifier on the display.

9. The mobile terminal of claim 7, further arranged to visualize previously accessed and unaccessed item identifiers in a separate fashion.

10. The mobile terminal of claim 7, further arranged to create a personalized feed by filtering data of at least one existing feed based on user preferences.

11. The mobile terminal of claim 7, wherein said action is selected from the group consisting of: launching an application, opening the item in the current application, and connecting the network for receiving further data.

12. The mobile terminal of claim 7, wherein said control input is selected from the group consisting of: a button press, directional controller data, voice command.

13. The mobile terminal of claim 7, wherein the type of the selected feed is one of the following: RSS (Really Simple Syndication), and Atom.

14. The mobile terminal of claim 7 that is operable in the GSM (Global System for Mobile communications) or UMTS (Universal Mobile Telecommunications System) network.

15. The mobile terminal of claim 7 that is a PDA (Personal Digital Assistant).

16. A computer program product comprising code means stored on a readable medium, the code means adapted, when the program is run on a computer device, to carry out the method steps as defined by claim 1.

17. A carrier medium having a computer executable program recorded thereon as defined by claim 16.

18. The carrier medium of claim 17 that is a memory card, a magnetic disk, or a cd-rom.
